(19) United States
(12) Patent Application Publication
(10) Pub. No.: US 2016/0165987 A1
(43) Pub. Date: Jun. 16, 2016

(54) PRESERVED FLOWER ARRANGEMENT AND METHOD FOR PRODUCING THE SAME

(71) Applicant: Miyuki MATSUMOTO, Osaka (JP)

(72) Inventor: Miyuki MATSUMOTO, Osaka (JP)

(21) Appl. No.: 14/957,892

(22) Filed: Dec. 3, 2015

Related U.S. Application Data
(63) Continuation of application No. PCT/JP2014/083160, filed on Dec. 15, 2014.

(51) Int. Cl. A41G 1/00; A01N 3/00

(52) U.S. Cl. CPC A41G 1/00; A01N 3/00

(57) ABSTRACT

A preserved flower arrangement includes a central core body obtained as a result of at least a plurality of petals being separated from a perianth of a rose preserved flower; and a plurality of outer petals each obtained as a result of causing a surface of each of the petals separated from the perianth to have a protrusion having an arcked cross-section. The outer petals each have the protrusion on the base end side of the surface. The protrusions of the plurality of outer petals located on a circumference of the central core body, and the central core body, are bonded and secured to each other.

### CROSS-REFERENCE TO RELATED APPLICATION

This application is a continuation of an International Application PCT/JP2014/083160 filed on Dec. 15, 2014, the entire contents of which are incorporated herein by reference.

### TECHNICAL FIELD

The present invention relates to a preserved flower arrangement using a preserved flower.

### BACKGROUND ART

A preserved flower is a flower obtained as a result a fresh flower being immersed in a chemical so as to be preservable for a long time, and is arranged as necessary to be used for a wedding bouquet or for an interior decoration item.

In this specification, the term “preserved flower arrangement” encompasses a processed preserved flower, and a combination of such preserved flowers that is produced as a bouquet, an interior decoration item or the like.

The “method for producing a preserved flower arrangement” refers to a method of processing a preserved flower to produce a preserved flower arrangement.

A preserved flower is preservable for a longer time without requiring watering or other cares as compared with a fresh flower, and thus is a target of attention. However, a preserved flower is brittle and easily breakable. For these reasons, a preserved flower is generally produced by processing a fresh flower in a bud state or a half-bloomed state in which petals are not expanded outside, not in a full-bloomed state in which the petals are vulnerable against an external force and are easily breakable.

Such a preserved flower in a bud state or a half-bloomed state has a beautiful external appearance with softness and freshness, but appears monotonous.

In order to solve such a problem, Patent Document 1 describes an invention providing a unique and beautiful preserved flower arrangement by performing two or more creative processes on separated petals. The term “creative process” refers to, for example, cutting, turning inside out, or turning upside down, the separated petals.

According to the invention described in Patent Document 1, petals are layered on each other to form a central part, and other petals created by two or more creative processes are secured to the central part with an adhesive. It is described that a beautiful preserved flower fully exhibiting the personality of a creator is provided in this manner.

According to the invention described in Patent Document 1, a flower of a shape that is not realized conventionally is created. However, the invention of Patent Document 1 creates a preserved flower arrangement by processing petals. Therefore, the produced preserved flower arrangement has a feature mainly in the shape or the positional arrangement of the petals. There is a limit on the degree of blooming or the shape of the central part of the preserved flower arrangement that can be produced by the invention of Patent Document 1.

### CITATION LIST

### Patent Literature

[Patent Document 1] Japanese Patent No. 3957216

### SUMMARY OF INVENTION

### Technical Problem

The present invention has an object of providing a preserved flower arrangement capable of having any of a variety of shapes and a method for producing the same.

### Solution to Problem

The present invention is directed to a preserved flower arrangement including a central core body obtained as a result of at least a plurality of petals being separated from a perianth of a preserved flower; and a plurality of outer petals each having a surface caused to have a protrusion. The protrusions of the plurality of outer petals located on a circumference of the central core body, and the central core body, are bonded and secured to each other.

The present invention is also directed to a method for producing a preserved flower arrangement including a central core body formation step of separating a plurality of petals from a perianth of a preserved flower to form a central core body; a protrusion formation step of causing each of outer petals to have a protrusion; and a bonding step of bonding and securing the outer petals located on a circumference of the central core body, and the central core body, to each other.

The “perianth” refers to an element of the preserved flower, and includes a flower receptacle and a corolla. The flower receptacle is at a tip of the stalk (branches and stem) and includes the stamen, the pistil, the calyx and the like. The petals are attached to the flower receptacle. The corolla is an assembly of the petals.

The “central core body” represent a concept encompassing, for example, a part of the corolla that is left as a result of a plurality of petals being separated from the corolla, which is obtained by separating the flower receptacle from the perianth, the flower receptacle left as a result of the corolla being separated from the perianth, an assembly of the part of the corolla that is left as a result of a plurality of petals being separated from the corolla and the flower receptacle, and an assembly of the corolla or the flower receptacle obtained as a result of the petals being separated and processed petals bonded thereto.

The term “outer petals” represents a concept encompassing, for example, petals separated from the perianth, petals separated from another preserved flower, petals separated from a fresh flower or a dry flower, petals artificially formed of, for example, a synthetic resin or the like, petals separated by a person other than a worker involved in the production of the preserved flower arrangement, and individual petals separately purchased.

The term “outer petals” also represents a concept encompassing, for example, petals separated from the same type of preserved flowers, and petals separated from different types of preserved flowers. The present invention is applicable to a case where either one of the outer petals or the petals are separated from a fresh flower or a dry flower, whereas the other of the outer petals or the petals are separated from a preserved flower.

The outer petals may have any shape. The outer petals may have a shape as they are at the time of being separated from the perianth or the corolla. Alternatively, for example, the outer petals may each have an end cut off with scissors or the like, may have cut-out parts or patterns in the entirety thereof or a part thereof, or may be deformed by bending or the like. In other words, for example, the outer petals may be shaped as they are or may be processed.

According to the present invention, a preserved flower arrangement having any of various shapes may be provided.

For example, the central core body may be a part left as a result of the plurality of petals being separated from the perianth. In this case, the central core body has the flower receptacle and the corolla integrated together in a natural state. Alternatively, for example, processed petals may be bonded to the flower receptacle obtained as a result of the petals being separated from the perianth. The central core body created in this manner may have a novel shape. Thus, the central core body, which is a central part of the preserved flower arrangement, may have a novel shape.

The projections of the outer petals and the central core body may be bonded and secured to each other. This allows the outer petals to be bonded and secured to the central core body in accordance with the shape of the projections. The angle at which the outer petals are bonded may be adjusted in accordance with the shape of the projections.

This will be described specifically. In the case where the projections each have an arcked cross-section, the position of the projection to be bonded to the central core body may be changed to adjust the angle at which the outer petal is to be bonded. This allows the outer petals to be bonded at a desired angle with respect to the central core body. Therefore, the outer petals may be bonded to the central core body capable of having any of various shapes, such that a desired bloomed state is provided.

The preserved flower arrangement produced in this manner may provide any of various representations; for example, the preserved flower arrangement may be, as a whole, in a state close to a naturally bloomed state, or may have a beautiful appearance that is not present in the natural world.

The outer petals may be petals separated from the same type of, or different types of, preserved flowers, or petals separated from a fresh flower or a dry flower. Use of such petals may provide a novel representation that is not realized by a conventional preserved flower arrangement. The preserved flower arrangement produced in this manner may represent any of various bloomed states or may embody any of various images or concepts.

According to an embodiment of the present invention, the central core body may include a flower receptacle part left as a result of a corolla being separated from the perianth; and flower core parts located along an outer circumference of the flower receptacle part, the flower core parts each including a plurality of petals. The plurality of outer petals are bonded and secured to the flower core parts.

Like the term “outer petals”, the term “petals” represents a concept encompassing, for example, petals separated from the corolla, petals separated from another preserved flower, petals separated from a fresh flower or a dry flower, petals separated by a person other than a worker involved in the production of the preserved flower arrangement, and individual petals separately purchased.

The term “petals” represents a concept encompassing, for example, petals separated from the same type of preserved flowers as that of the outer petals, and petals separated from a different type of preserved flowers from that of the outer petals. The present invention is applicable to a case where either one of the outer petals or the petals are separated from a fresh flower or a dry flower, whereas the other of the outer petals or the petals are separated from a preserved flower.

The expression “including (a plurality of) petals” refers to, for example, a case where each of the petals have a shape as it is at the time of being separated from the corolla, a case where a plurality of the separated petals are layered regularly or irregularly, a case where each of, or a plurality of, the petals are bent, a case where each of, or a plurality of, the petals are rounded, a case where a plurality of the separated petals are bent regularly or irregularly, or a case where the petals having any of the above-described structures are processed by use of scissors or the like.

According to the present invention, the central core body, which is the central part of the preserved flower arrangement, may have any of various shapes. The preserved flower arrangement produced in this manner may have a shape of an actual flower or may have a unique central part that is not present in the natural world. Such a preserved flower arrangement may have a beautiful appearance.

According to an embodiment of the present invention, the preserved flower arrangement may further includes a flower receptacle wire passing through the flower receptacle part in a direction crossing an extension direction in which the flower receptacle part extends, the flower receptacle wire being bent such that two ends thereof are directed downward in the extension direction, and being secured to the flower receptacle part; and flower core wires passing through the flower core parts, the flower core wires being bent such that two ends of each thereof are directed in a predetermined direction, and being secured to the flower core parts. The flower receptacle wire and the flower core wires are secured to each other.

The “extension direction” is a direction in which the flower receptacle part extends, namely, a direction in which the flower receptacle part extends between the stem and the center of the corolla.

The “predetermined direction” is a direction in which, in the case where the flower core parts are located in the circumferential direction of the flower receptacle part, the flower core wires are directed in the same direction as that of the flower receptacle wire. In other words, the “predetermined direction” is a direction in which, in the case where the flower core parts are located in the circumferential direction of the flower receptacle part, the flower core wires, passing through the flower core parts and are bent at both of two ends thereof, are directed in the same direction as the direction in which the flower receptacle wire is bent.

The flower receptacle wire and the flower core wires may be formed of any material that has a required strength and is bendable manually or by use of a tool. The flower receptacle wire and the flower core wires may be wires formed of, for example, stainless steel, iron, brass, an aluminum alloy, a titanium alloy or any other alloy.

According to the present invention, the flower receptacle part and the flower core parts that are included in the central core body may be secured to each other strongly.

This will be described in more detail. The preserved flower arrangement may further include the flower receptacle wire that passes through the flower receptacle part, is bent such that two ends thereof are directed downward in the extension direction, and is secured to the flower receptacle part; and the flower core wires that pass through the flower core parts and are bent such that two ends of each thereof are directed in a predetermined direction. Owing to this structure, the flower core wires passing through the flower core parts located along the outer circumference of the lower receptacle part may be directed in the same direction as that of the flower receptacle wire.

The flower receptacle wire is secured to the flower receptacle part. Therefore, in the case where the flower core parts are bonded and secured to the flower receptacle part, and then the flower core wires are coiled around the flower receptacle wire, or the flower core wires and the flower receptacle wire are secured together with the tape; the flower core parts and the flower receptacle part are secured to each other. As a result, the flower core parts and the flower receptacle part are strongly secured to each other, and are provided as an integral body.

Therefore, even in the case where, for example, relatively large outer petals or a large number of outer petals are bonded to the flower core parts, the flower core parts sufficiently support the weight of the plurality of petals bonded thereto and are kept secured to the flower receptacle part. The preserved flower arrangement produced in this manner may have a gorgeous appearance and a shape that is not realized conventionally.

According to an embodiment of the present invention, the flower core parts may be each formed of a divided corolla obtained as a result of the corolla being divided along an extension direction in which the flower receptacle part extends.

According to the present invention, the preserved flower arrangement may be produced quickly.

As described above, the preserved flower, which is obtained as a result of a fresh flower being immersed in a chemical, is kept beautiful for a long time, but has a disadvantage of being brittle against an external force. In the case where, for example, the production of the preserved flower arrangement is time-consuming or requires many steps, the possibility that an external force is applied to the petals and the like is made high. This increases the possibility of the petals and the like being broken.

The present invention allows the flower core parts to be prepared in a short time with no need to separate the petals one by one from the corolla including a predetermined number of the petals. Therefore, the preserved flower arrangement is produced quickly.

Since the preserved flower arrangement is produced quickly, the damage on the petals is decreased. This also decreases the number of preserved flowers required to produce the preserved flower arrangement, and thus decreases the cost.

The manner in which the petals included in each of the separated flower core parts are layered on each other is close to a natural state, unlike the manner in which the petals are artificially layered on each other. The resultant preserved flower arrangement may have a novel shape that is not realized conventionally.

According to an embodiment of the present invention, the petals included in each of the flower core parts may be bent around a phantom line connecting a base end and a tip end of the petals to form a curved petal body.

The term “curved petal body” refers to a concept encompassing petals that are bent such that surfaces thereof facing each other are entirely layered on each other, and petals that are bent such that surfaces thereof facing each other are partially layered on each other

According to the present invention, the central core body has a three-dimensional shape expanding in a direction crossing the extension direction, and the central part of the preserved flower arrangement is made gorgeous. The resultant preserved flower arrangement may have a shape that is not realized conventionally.

This will be described in more detail. The flower core parts bent as described above may be located in the circumferential direction of the flower receptacle part. This allows the central core body to expand in a direction crossing the extension direction. The bent flower core parts have lines directed toward the center of the flower receptacle part, in addition to expanding three-dimensionally. The preserved flower arrangement produced in this manner has lines extending toward the center of the central core body, in addition to a conventionally available shape in which the petals and the like are stacked in the circumferential direction of the central core body. The preserved flower arrangement produced in this manner may have the central core body having a gorgeous structure and provide a novel representation that is not realized conventionally.

The central part of the bent petals each including a phantom line connecting a tip end and another end thereof may be represented by a curved line. In this case, the central core body in which the flower core parts having such curved lines are located on the circumference of the flower receptacle part may provide a softer impression.

According to an embodiment of the present invention, the curved petal body may include the plurality of petals layered on each other.

The term “layered” refers to, for example, a case where the petals are layered so as to be directed in the same direction, a case where the petals are layered so as to be directed in different directions, and a case where the plurality of petals are partially layered on each other.

According to the present invention, the central core body is thicker in a direction crossing the extension direction and has a gorgeous appearance because of the curved lines overlapping each other. The resultant preserved flower arrangement may appear more beautiful.

### Advantageous Effects of Invention

The present invention provides a preserved flower arrangement having a novel shape that is not realized conventionally and a method for producing such a preserved flower arrangement.

### BRIEF DESCRIPTION OF DRAWINGS

FIG. 1 is a schematic isometric view of a preserved flower arrangement.

FIG. 2 is a flowchart showing a method for producing the preserved flower arrangement.

FIG. 3 is an exploded isometric view of a preserved flower.

FIG. 4A to 4C show a step of creating a flower receptacle part.

FIG. 5A to 5C show a corolla division step and a corolla bending step.

FIG. 6A to 6C show a step of creating a flower core part.

FIGS. 7A and 7B show how to bond and secure the flower core parts and the flower receptacle part to each other.

FIGS. 8A and 8B show how to bond and secure the flower core parts and the flower receptacle part to each other.

FIGS. 9A and 9B show a bonding step of bonding outer petals to a central core body.

FIG. 10A to 10D show how to adjust the angle of an outer petal to be bonded to the central core body.

FIGS. 11A and 11B show the bonding step of bonding the outer petal to the central core body.

FIG. 12A to 12C show a curing step for one petal.

FIG. 13 is a schematic isometric view of the preserved flower.

### DESCRIPTION OF EMBODIMENTS

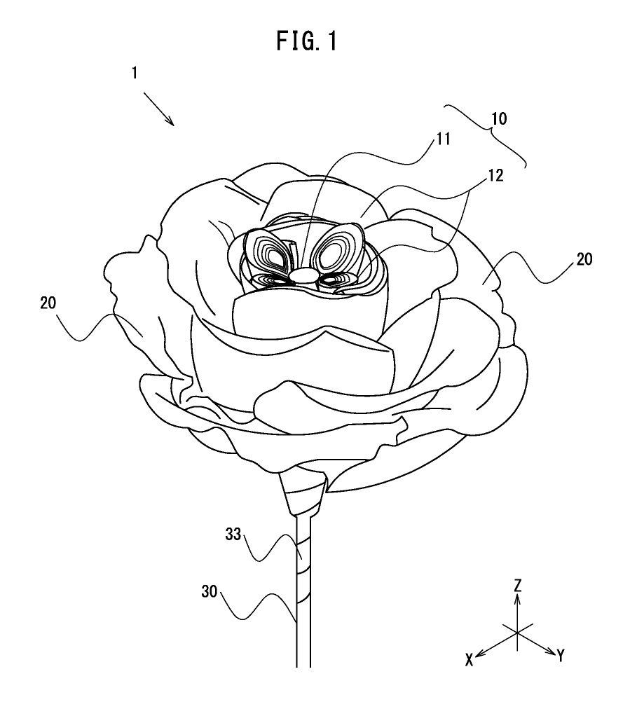

Hereinafter, a preserved flower arrangement according to the present invention will be described with reference to FIG. 1 through FIG. 13.

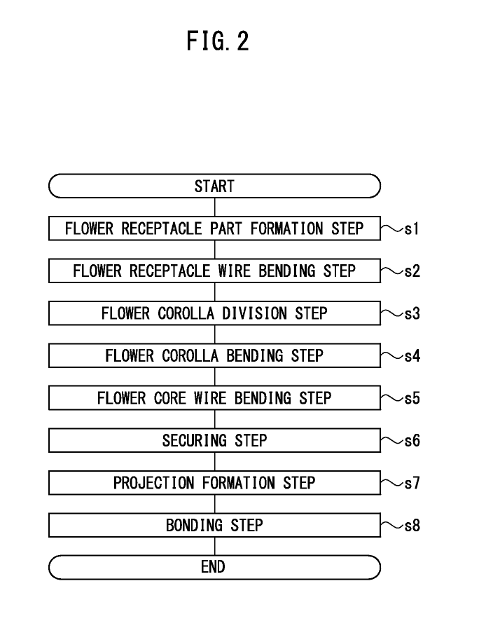

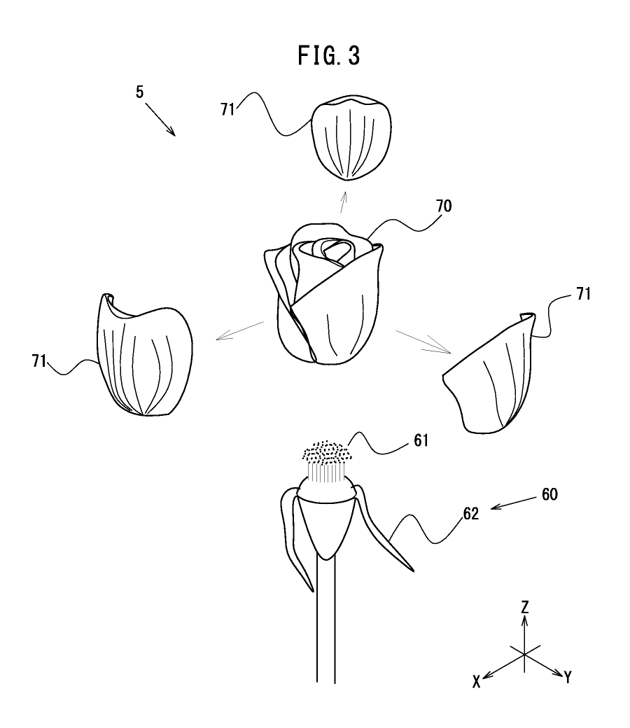

FIG. 1 is a schematic isometric view of a rose preserved flower arrangement 1. FIG. 2 is a flowchart showing a method for producing the rose preserved flower arrangement 1. FIG. 3 through FIG. 11 show how to create the elements along with the flowchart.

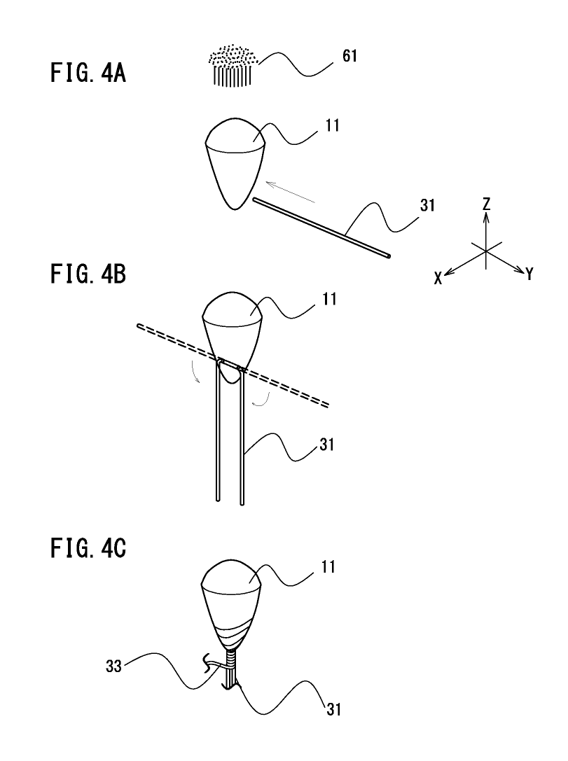

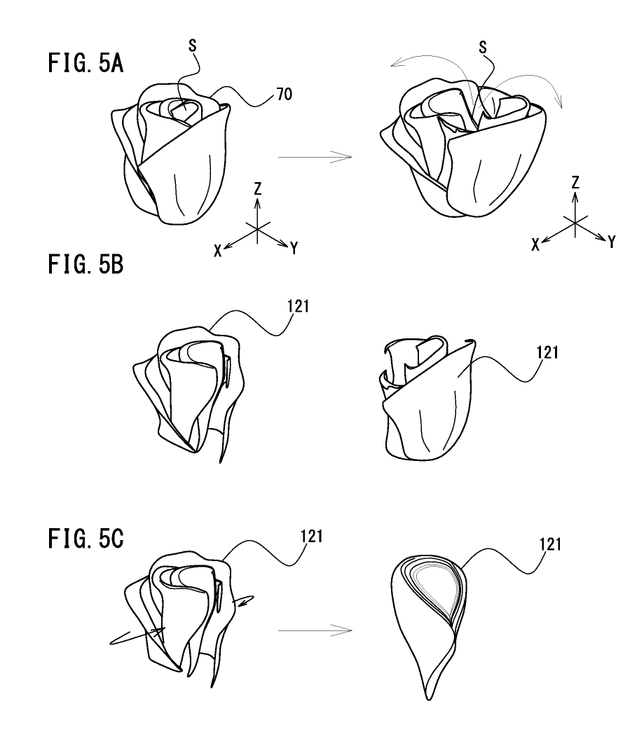

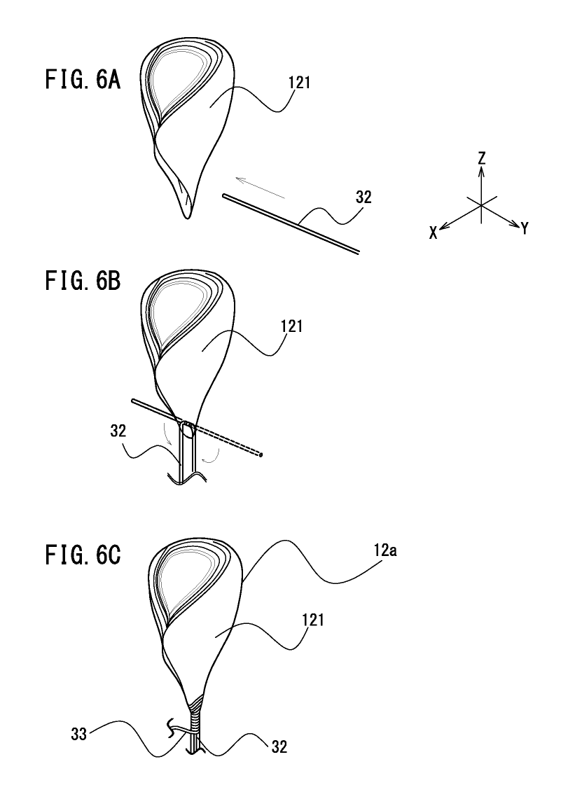

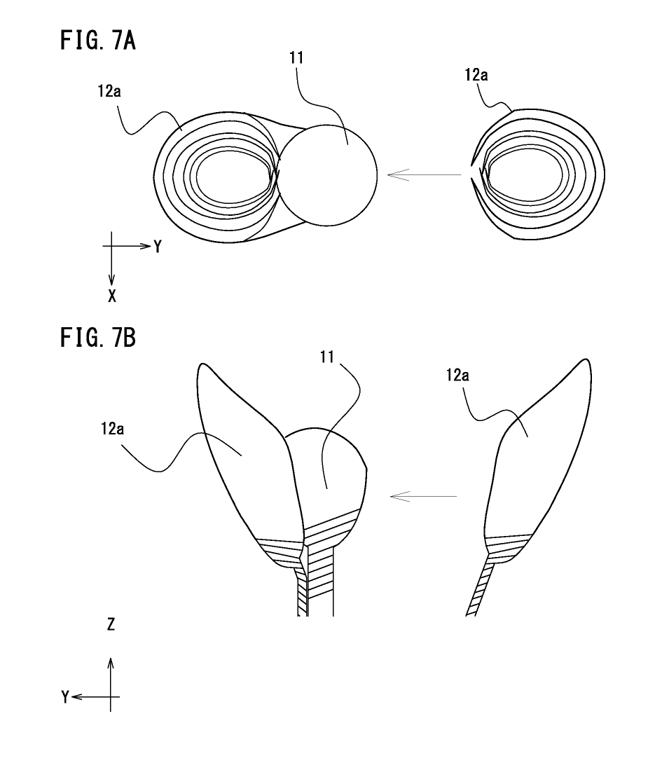

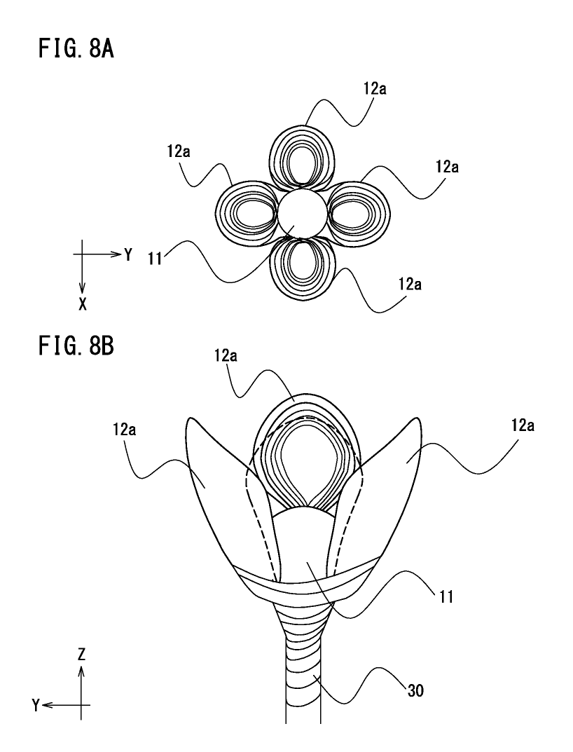

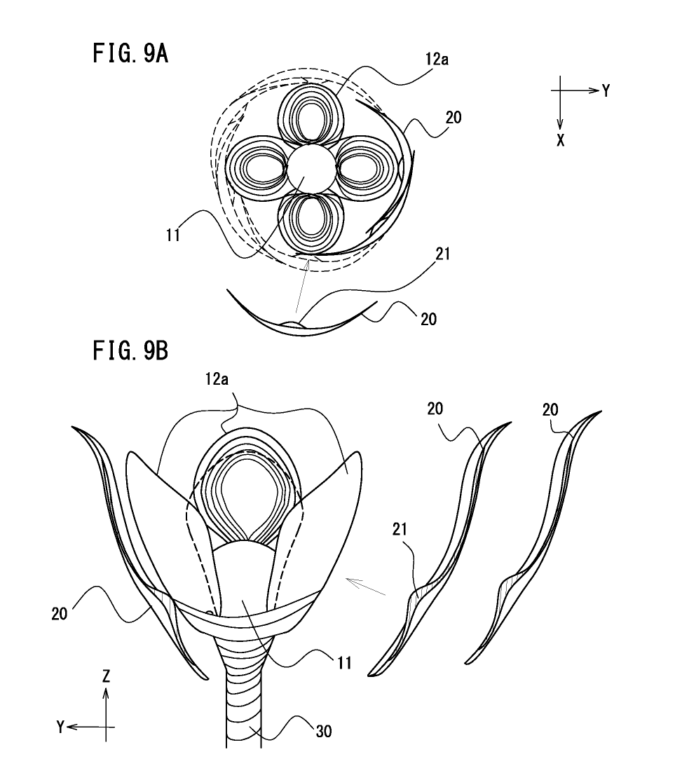

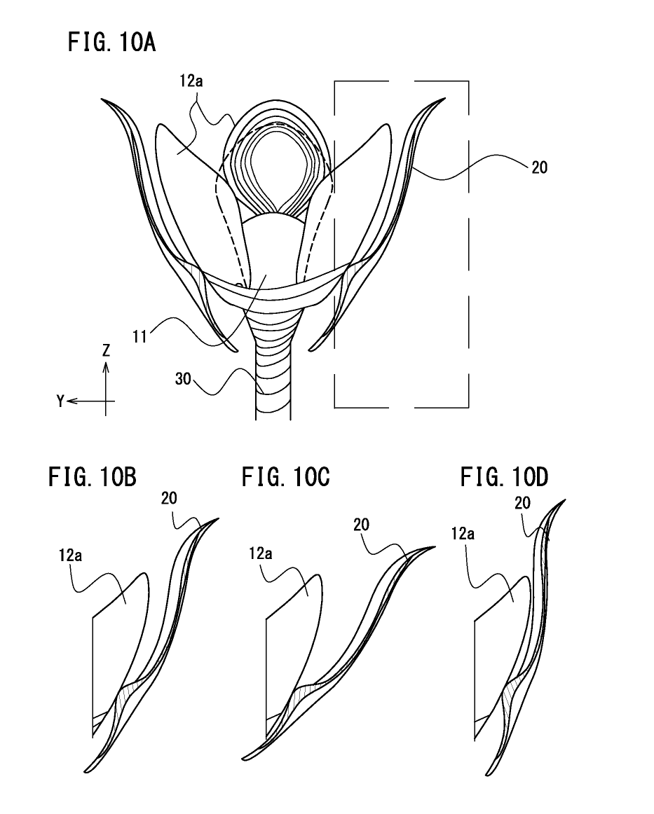

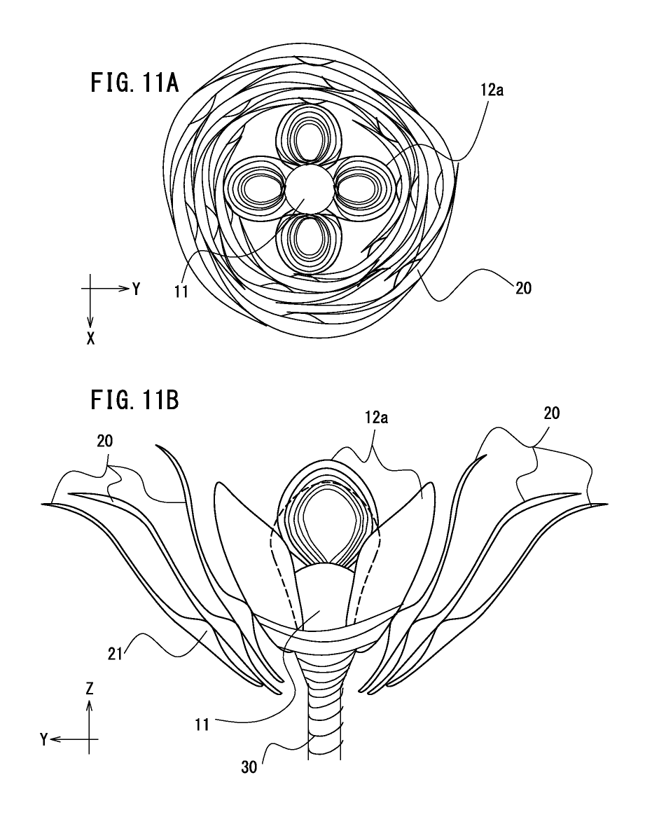

This will be described specifically. FIG. 3 is an exploded isometric view of a rose preserved flower 5. FIG. 4A to 4C show a step of producing a flower receptacle part 11. FIG. 5A to 5C and FIG. 6A to 6C show a step of producing a flower core part 12. FIG. 7A, FIG. 7B, FIG. 8A and FIG. 8B show how to bond and secure the flower receptacle part 11 and the flower core parts 12 to each other. FIG. 9A, FIG. 9B, FIG. 11A and FIG. 11B show a bonding step of bonding outer petals 20 to a central core body 10. FIG. 10A to 10D show how to adjust the angle of an outer petal to be bonded to the central core body.

This will be described in more detail. FIG. 7A and FIG. 8A are each a plan view showing how to bond and secure the flower receptacle part 11 and the flower core parts 12 to each other. FIG. 7B and FIG. 8B are each a side view showing how to bond and secure the flower receptacle part 11 and the flower core parts 12 to each other. FIG. 9A and FIG. 11A are each a plan view showing how to bond and secure the outer petals 20 to the central core body 10. FIG. 9B and FIG. 11B are each a side view showing how to bond and secure the outer petals 20 to the central core body 10.

FIG. 10A is a side view showing how to bond and secure the outer petals 20 to the central core body 10. FIG. 10B, FIG. 10C and FIG. 10D are each an enlarged view of a part enclosed by the dashed line in FIG. 10A, and each show how to adjust the angle of the outer petals 20 to be bonded to the central core body.

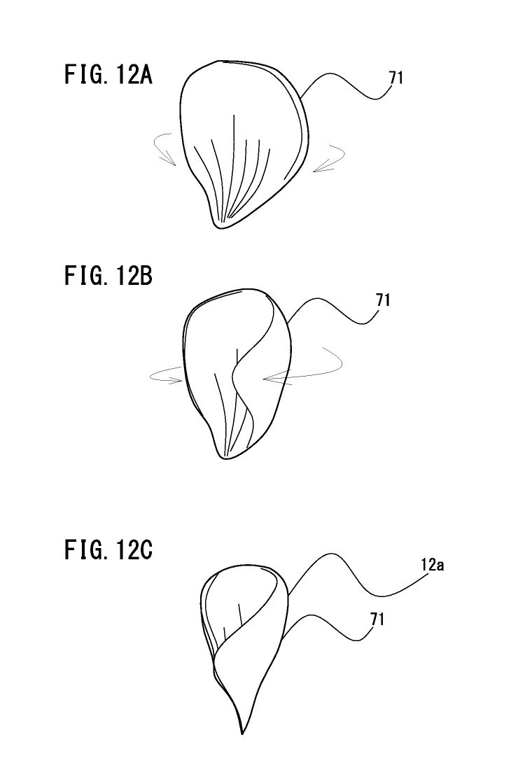

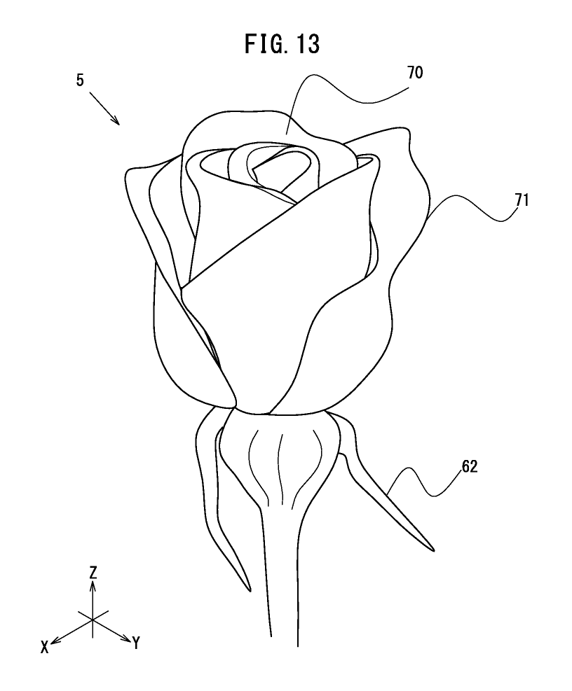

FIG. 12A to 12C show a bending step for one petal. FIG. 13 is a schematic isometric view of the preserved flower 5.

In FIG. 1, FIG. 3 and FIG. 13, a direction in which a stalk of the rose preserved flower arrangement 1 or the rose preserved flower 5 extends is defined as an up-down direction (Z axis direction). A direction toward a perianth along the stalk is defined as an upward direction (+Z direction), and the opposite direction is defined as a downward direction (−Z direction). A direction that is perpendicular to the Z axis direction and extends between the right and the left, obliquely away from, and toward, the viewer of these figures is defined as an X axis direction. A direction extending obliquely to the left and away from the viewer is defined as a −X direction, and a direction extending obliquely to the right and toward the viewer is defined as a +X direction. A direction that is perpendicular to the Z axis direction and the X axis direction is defined as a Y axis direction. A direction extending obliquely to the left and away from the viewer is defined as a −Y direction, and a direction extending obliquely to the right and toward the viewer is defined as a +Y direction.

In FIG. 4 through FIG. 11, the directions are the same as those in FIG. 1. As shown in FIG. 1, the rose preserved flower arrangement 1 includes the central core body 10, which is a central part of the flower, the outer petals 20 bonded to an outer circumference of the central core body, and a stem body 30.

The central core body 10 includes a flower receptacle part 11 formed in a central part of the rose preserved flower arrangement 1 and the flower core parts 12 located on a circumference of the flower receptacle part 11.

The flower receptacle part 11 is apart that is left after the rose preserved flower 5 is disassembled into a flower receptacle 60 and a corolla 70 and a reproductive organ 61 such as the stamen, the pistil and the like, calyx 62 and the like are removed from the flower receptacle 60 (see FIG. 3 and FIG. 4A). The flower receptacle part 11 has a shape of a cone that is hemispherical at the top.

In this embodiment, the reproductive organ 61, the calyx 62 and the like are removed. The reproductive organ 61, the calyx 62 and the like do not necessarily need to be removed. The flower receptacle 60 having one of the reproductive organ 61 and the calyx 62 removed, or having both of the reproductive organ 61 and the calyx 62 left therein, may be used as the flower receptacle part 11.

The flower core part 12 is a generally circular truncated conical body and is formed as follows. The corolla 70 including a plurality of petals 71 is divided into two to obtain divided corollas 121, and each divided corolla 121 is curved. Four flower core parts 12 are located on the circumference of the flower receptacle part 11 at an equal interval.

The outer petals 20 are petals 71 (see FIG. 13) separated from the corolla 70 and bonded to the circumference of the central core body 10. The outer petals 20 each have a surface caused to have a protrusion 21.

The protrusion 21 protrudes from the outer side to the inner side of the petal, namely, from a rear surface to a front surface of the outer petal. The protrusion 21 is formed in the vicinity of a base end of the outer petal 20 so as to have an arcked cross-section.

In this embodiment, the outer petals 20 are the petals 71 separated from the corolla 70. The present invention is not limited to this embodiment. For example, the outer petals 20 may be petals separated from another preserved flower, petals separated from a fresh flower or a dry flower, petals artificially formed of, for example, a synthetic resin or the like. Alternatively, the outer petals 20 may be petals separated by a person other than a worker involved in the production of the preserved flower arrangement, or individual petals separately purchased.

The stem body 30 forming a stem part of the rose preserved flower arrangement 1 includes a flower receptacle wire 31 (see FIG. 4A to 4C), a plurality of flower core wires 32 (FIG. 6A to 6C), and a tape 33.

The flower receptacle wire 31 passes through a bottom part of the flower receptacle part 11 in the Y axis direction and is bent such that both of two ends thereof are directed downward (−Z axis direction). The tape 33 is put around a part from a bottom end part of the flower receptacle part 11 to the both ends of the flower receptacle wire 31, so that the flower receptacle wire 31 is secured (see FIG. 4A to 4C).

Similarly, each of the flower core wires 32 passes through a bottom part of the flower core part 12 and is bent such that both of two ends thereof are directed downward in FIG. 6A to 6C. The tape 33 is put around a part from a bottom end part of the flower core part 12 to the both ends of the flower core wire 32, so that the flower core wire 32 is secured (see FIG. 6A to 6C).

The tape 33 is green, and is put around each of the flower receptacle wire 31 and the flower core wire 32 as described above, and is also put around the flower receptacle wire 31 and the plurality of flower core wires 32, which are already bonded and secured to each other.

In this embodiment, the tape 33 is green, which is the color of the stem. The color of the tape 33 is not limited to green. In the case where, for example, the rose preserved flower arrangement 1 is used for a wedding bouquet or the like, the tape 33 may be white in conformity to the color of the underlying material or the overall color of the wedding bouquet. In other words, the tape 33 may have any color, and the color of the tape 33 may be appropriately changed in accordance with the form of use or the rose preserved flower arrangement 1 to be produced.

Hereinafter, a method for producing the rose preserved flower arrangement 1 having the above-described structure will be briefly described with reference to FIG. 2 through FIG. 11.

As shown in FIG. 2, the rose preserved flower arrangement 1 is produced by eight steps from a flower receptacle part formation step (step s1) to the bonding step (step s8).

First, in the flower receptacle part formation step (step s1), the corolla 70 is separated from the rose preserved flower 5 to leave the flower receptacle 60 (see FIG. 3). From the left flower receptacle 60, the reproductive organ 61 and the calyx 62 are removed to prepare the flower receptacle part 11.

Next, as shown in FIG. 4A to 4C, the flower receptacle wire 31 is caused to pass through the bottom end part of the flower receptacle part 11 in the −Y direction from a +Y side (see FIG. 4A), and adjustment is made such that the lengths of parts of the flower receptacle wire 31 extending from the flower receptacle part 11 in the +Y direction and the −Y direction are approximately equal to each other. Then, as shown in FIG. 4B, the exposed parts of the flower receptacle wire 31 passing through the flower receptacle part 11 are bent such that both of the two ends thereof are directed downward (−Z direction). In a final step, as shown in FIG. 4C, the tape 33 is put around a part from the bottom end part of the flower receptacle part 11 to the ends of the flower receptacle wire 31 (step s2). As a result, the flower receptacle part 11 having the flower receptacle wire 31 strongly secured thereto is obtained. In this process, a plastic adhesive may be applied to the through-hole through which the flower receptacle wire 31 passes, so that the flower receptacle wire 31 is secured more strongly.

Next, in order to create the flower core parts 12, the following steps are performed: a corolla division step (step s3) of dividing the corolla 70 into two to create the divided corollas 121, a corolla bending step (step s4) of bending the divided corollas 121, and a flower core wire bending step (step s5) of causing the flower core wires 32 to pass through the bent divided corollas 121 and bending the flower core wires 32.

This will be described specifically. From the corolla 70 separated from the rose preserved flower 5, the plurality of petals 71 are separated carefully (see FIG. 3). As shown in FIG. 5A to 5C, the corolla 70 including an appropriate number of petals left is divided carefully into two approximately equally in the Z axis direction (see FIG. 5A).

This will be described in more detail. The appropriate number of petals left in the corolla 70, namely, a plurality of petals 71, are each U-shaped as seen in a plan view (not shown). An opening of each petal 71 is directed toward the center of the corolla 70. The opening of the U-shaped petal 71 is formed so as to wrap the petal 71 facing thereto. Therefore, the corolla 70 has a central space S at the center thereof. Originally in the central space S, the flower receptacle 60 was present and protected by the corolla 70.

A mild force is applied from the central space S in a direction opposite to the direction from each petal 71 to the opening, so that the corolla 70 is divided.

This will be described in more detail. For example, a finger is put into the central space S formed in the corolla 70, and a mild force is applied to the petals 71 facing each other at the center of the corolla 70. The mild force is applied in the direction opposite to the direction from each petal 71 to the opening. Thus, the U-shaped petals facing each other are separated (see FIG. 5A). Assemblies of the petals 71 separated in this way are each defined as the divided corolla 121 (see FIG. 5B).

Each of the divided corollas 121 obtained by such separation of the corolla 70 is shape-adjusted and is bent around a phantom line connecting a base end and a tip end of the petals 71 included in the divided corolla 121 (see FIG. 5C). In this process, each divided corolla 121 is bent such that contact faces of the petals 71 on abase end side (−Z side) are generally layered on each other, and that the petals 71 make a large arc on a tip end side (+Z side) (step s4). In other words, each divided corolla 121 is bent such that a part thereof around the phantom line connecting the base end and the tip end of the petals included in the divided corolla 121 is curved.

Next, as shown in FIG. 6A to 6C, the flower core wire 32 is caused to pierce the bottom part of each of the bent divided corollas 121 such that the flower core wire 32 passes through the part in which the petals are layered on each other. Then, the exposed parts of the flower core wire 32 are bent such that both of the bottom ends thereof are directed downward (step s5). As shown in FIG. 6C, the tape 33 is put around a part from the bottom part of the divided corolla 121 to the ends of the flower core wire 32, so that the divided corolla 121 and the flower core wire 32 are secured to each other. As a result, a curved petal body 12a including the curved divided corolla 121 and having the bottom part thereof secured is obtained.

Like in the case of creating the flower receptacle part 11, in the process of causing the flower core wire 32 to pierce the divided corolla 121, the flower core wire 32 and the through-hole in the curved petal body 12a may be secured to each other with a plastic adhesive or the like. Alternatively, in the process of bending the divided corolla 121, contact faces of the petals, for example, contact faces of the petals in a base end part may be secured to each other with a plastic adhesive or the like.

Next, a securing step (step s6) of bonding and securing the flower receptacle part 11 and the curved petal bodies 12a formed as described above to each other is performed.

This will be described specifically. The curved petal bodies 12a are located so as to hold the flower receptacle part 11 in the Y axis direction. In this process, the directions of the curved petal bodies 12a are adjusted such that the layered parts of the petals of the curved petal bodies 12a are directed toward the flower receptacle part 11 (see FIG. 7A). The curved petal bodies 12a are put into contact with the flower receptacle part 11 such that parts of the curved petal bodies 12a above parts secured by the tape 33 hold the flower receptacle part 11, and the curved petal bodies 12a and the flower receptacle part 11 are bonded and secured to each other with a plastic adhesive (see FIG. 7A and FIG. 7B).

In a similar manner, the flower core parts 12 are located so as to hold the flower receptacle part 11 in the X axis direction, and the flower receptacle part 11 and the curved petal bodies 12a are secured to each other with a plastic adhesive (see FIGS. 8A and 8B).

In this process, the flower core wires 32 passing through the respective flower core parts 12 are adjusted to be directed in the same direction as that of the flower receptacle wire 31 (−Z axis direction) passing through the flower receptacle part 11, and the tape 33 is put around, and secures together, the flower receptacle wire 31 and the flower core wires 32. This strongly secures the flower receptacle wire 31 and the flower core wires 32. Therefore, the flower receptacle part 11 and the curved petal bodies 12a are secured more strongly than in the case of being secured with merely a plastic adhesive. In this manner, the flower receptacle part 11 and the curved petal bodies 12a are secured to each other to form the central core body 10.

In this embodiment, four curved petal bodies 12a are located at an equal interval so as to enclose the flower receptacle part 11. The number of the curved petal bodies 12a does not need to be four, and may be, for example, two, three, or any number of two or greater. In the case where four or five curved petal bodies 12a are used, the flower receptacle part 11 is enclosed by the curved petal bodies 12a with a good balance and a high level of design.

Next, the protrusion 21 is formed for each outer petal 20 (step s7), and the bonding step (step s8) of sequentially locating, and bonding, the outer petals 20 in a circumferential direction of the central core body 10 is performed.

First, the rear surface of each outer petal 20 is pressed with a finger at the bottom end on the base end side such that the front surface of the outer petal 20 is caused to have the protrusion 21 (not shown). Next, the outer petals 20 are located on an outer circumferential surface of the central core body 10 such that the protrusions 21 of the outer petals 20 contact the curved petal bodies 12a, in other words, such that the protrusions 21 are directed toward the central core body 10. The outer petals 20 are bonded to the central core body 10 with a plastic adhesive (see FIGS. 9A and 9B).

As shown in FIG. 10A to 10D, the protrusion 21 of each outer petal 20 has an arcked cross-section. The angle of the outer petal 20 is freely adjustable by changing the part of the protrusion 21, caused to have such an arcked cross-section, that is to contact the curve petal body 12.

This will be described specifically with reference to FIG. 10B through FIG. 10D. In the case where, for example, an apex part of the protrusion 21, which protrudes most significantly, is put into contact with the curved petal body 12a, the outer petal body 20 is generally parallel to the contact face of the curved petal body 12a (see FIG. 10B).

In the case where, for example, a part of the protrusion 21 that extends from the apex to a position close to the base end of the outer petal 20 is put into contact with the surface of the curved petal body 12a (see FIG. 10C), a tip end of the outer petal 20 is far from the curved petal body 12a. In other words, the angle of the outer petal 20 with respect to the curved petal body 12a is larger than that in the case where the apex of the protrusion 21 is bonded to the curved petal body 12a. Thus, the rose preserved flower arrangement 1 is created to be in a bloomed state where the petals are opened.

By contrast, in the case where a part of the protrusion 21 that extends from the apex to a position close to the tip end of the outer petal 20 is put into contact with the curved petal body 12a (see FIG. 10D), the tip end of the outer petal 20 is close to the curved petal body 12a. In other words, the rose preserved flower arrangement 1 is created to be in a state close to a bud or in a half-bloomed state.

As described above, an adjustment may be made on which part of the protrusion 21 is to be put into contact with the central core body 10 (curved petal body 12a), so that the angle of the outer petal 20 with respect to the central core body 10 is changed, namely, is adjusted to a desired angle.

Next, other outer petals 20 are sequentially bonded in the circumferential direction of the central core body 10 while being positionally shifted. In this process, the outer petals 20 to be newly bonded are located so as to be partially layered on the outer petals 20 already located, and thus bonded and secured. Locating the outer petals 20 in such a layering manner allows the ends of the outer petals 20 already bonded to be protected by the newly bonded outer petals 20, and also allows adjacent outer petals 20 to be bonded to each other more strongly. This prevents the outer petals 20 from being peeled off from the central core body 10 or the like.

In this embodiment, about five or six outer petals 20 are located to cover the entire circumference of the central core body 10. The present invention is not limited to this embodiment. The rose preserved flower arrangement 1 produced by use of such a number of outer petals has a good balance and a good external appearance.

In this manner, the outer petals 20 are sequentially bonded on the circumference of the central core body 10 such that the adjacent outer petals 20 are layered on each other. This allows the angle of the outer petals 20 to be adjusted appropriately such that a bloomed state is created. Therefore, the resultant rose preserved flower arrangement 1 includes the central core body 10 unique in the flower core part and the outer petals 20 provided in a plurality of layers to represent a bloomed state.

The rose preserved flower arrangement 1 formed as described above includes the central core body 10 obtained as a result of at least a plurality of petals 71 being separated from the perianth of the rose preserved flower 5; and the outer petals 20 each having a surface caused to have the protrusion 21. The protrusions 21 of the plurality of outer petals 20 located on the circumference of the central core body 10, and the central core body 10, are bonded and secured to each other. The resultant rose preserved flower arrangement 1 may have any of various shapes.

For example, the central core body 10 may include the flower receptacle part 11 obtained as a result of the petals 71 being separated from the perianth, and processed curved petal bodies 12a bonded to the flower receptacle part 11. The central core body 10 created in this manner may have a novel shape. The central core body 10, which is the central part of the rose preserved flower arrangement 1, may have a novel shape.

The shape of the protrusion 21 of each outer petal 20 is usable to adjust the angle at which the outer petal 20 is bonded to the central core body 10. The outer petal 20 may be bonded at a desired angle with respect to the central core body 10.

Therefore, the outer petals 20 may be bonded to the central core body 10 having the novel shape, such that a desired bloomed state is provided. The rose preserved flower arrangement 1 produced in this manner may be, as a whole, in a state close to a naturally bloomed state, or may have a beautiful appearance that is not present in the natural world.

The method for producing the preserved flower arrangement 1 includes a central core body 10 formation step of separating the plurality of petals 71 from the perianth of the preserved flower 5 to form the central core body 10; a protrusion 21 formation step of causing each of the outer petals 20 to have the protrusion 21; and the bonding step of bonding and securing the petals 71 located on the circumference of the central core body 10, and the central core body 10, to each other. Such a method for producing the preserved flower arrangement 1 has substantially the same effect as described above.

Usable as the petals 71 are not limited to the petals of the same type of, or different types of, preserved flowers. The petals 71 may be separated from a fresh flower or a dry flower. Use of such petals may provide a novel preserved flower arrangement not realized conventionally. The rose preserved flower arrangement 1 produced in this manner may represent any of various bloomed states or may have a beautiful appearance that is not present in the natural world.

The central core body 10 may include the flower receptacle part 11 left as a result of the corolla 70 being separated from the perianth; and the flower core parts 12 located along the outer circumference of the flower receptacle part 11. The flower core parts 12 may each include a plurality of petals 71. The plurality of outer petals 20 may be bonded and secured to the flower core parts 12. In this case, the central core body 10, which is the central part of the rose preserved flower arrangement 1, may have any of various shapes. The rose preserved flower arrangement 1 produced in this manner may have a shape of an actual flower or may have a unique central part that is not actually present.

The rose preserved flower arrangement 1 may further include the flower receptacle wire 31 that passes through the flower receptacle part 11 in a direction crossing an extension direction in which the flower receptacle part 11 extends, is bent such that two ends thereof are directed downward in the extension direction, and is secured to the flower receptacle part 11; and the flower core wires 32 that pass through the flower core parts 12, are bent such that two ends of each thereof are directed in a predetermined direction, and are secured to the flower core parts 12. The flower receptacle wire 31 and the flower core wires 32 may be secured to each other. In the resultant rose preserved flower arrangement 1, the flower receptacle part 11 and the flower core parts 32 that are included in the central core body 10 may be secured to each other strongly.

This will be described in more detail. The rose preserved flower arrangement 1 may further include the flower receptacle wire 31 that passes through the flower receptacle part 11, is bent such that two ends thereof are directed downward in the extension direction, and is secured to the flower receptacle part 11; and the flower core wires 32 that pass through the flower core parts 12 and are bent such that two ends of each thereof are directed in a predetermined direction. Owing to this structure, the flower core wires 32 passing through the flower core parts 12 located along the outer circumference of the lower receptacle part 11 may be directed in the same direction as that of the flower receptacle wire 31.

The flower receptacle wire 31 is secured to the flower receptacle part 11. Therefore, the flower core parts 12 is bonded and secured to the flower receptacle part 11 and then the flower core wires 32 and the flower receptacle wire 31 are secured together with the tape 33, so that the flower core parts 12 and the flower receptacle part 11 are bonded and secured to each other more strongly. As a result, the flower core parts 12 and the flower receptacle part 11 are strongly secured to each other, and are provided as an integral body.

Therefore, even in the case where, for example, relatively large outer petals 20 or a large number of outer petals 20 are bonded to the flower core parts 12, the flower core parts 12 sufficiently support the weight of the plurality of petals 71 bonded thereto and are kept secured to the flower receptacle part 11. The rose preserved flower arrangement 1 produced in this manner may have a gorgeous appearance and a shape that is not realized conventionally.

Moreover, an item that is slightly heavy, for example, an ornament designed based on a honey bee or the like, may be put on the flower core parts 12. The rose preserved flower arrangement 1 produced in this manner may have a novel appearance that is not conceivable conventionally.

In this embodiment, the flower receptacle wire 31 and the flower core wires 32 are secured to each other with the tape 33. The present invention is not limited to this embodiment. For example, the flower core wires 32 may be coiled around the flower receptacle wire 31 to be secured thereto, or the flower receptacle wire 31 and the flower core wires 32 may be engaged with each other. In other words, there is no limitation on the form of securing as long as the flower receptacle wire 31 and the flower core wires 32 are bonded and secured to each other.

The flower core parts 12 may each be formed of the divided corolla 121 obtained as a result of the corolla 70 being divided along the extension direction. This allows the rose preserved flower arrangement 1 to be produced quickly.

As described above, the rose preserved flower 5, which is obtained as a result of a fresh flower being immersed in a chemical, is kept beautiful for a long time, but has a disadvantage of being brittle against an external force. In the case where, for example, the production of the rose preserved flower arrangement 1 performed by use of the rose preserved flower 5 is time-consuming or requires many steps, the possibility that an external force is applied to the petals 71 and the like is made high. This increases the possibility of the petals 71 and the like being broken.

The present invention allows the flower core parts 12 to be prepared in a short time with no need to separate the petals 71 one by one from the corolla 70 including a predetermined number of the petals 71. Therefore, the rose preserved flower arrangement 1 is produced quickly.

Since the rose preserved flower arrangement 1 is produced quickly, the damage on the petals 71 is decreased. This also decreases the number of rose preserved flowers 5 required to produce the rose preserved flower arrangement 1, and thus decreases the cost.

The manner in which the petals 71 included in each of the separated flower core parts 12 are layered on each other is close to a natural state, unlike the manner in which the petals 71 are artificially layered on each other. The resultant rose preserved flower arrangement 1 may have a novel shape that is not realized conventionally.

The petals 71 included in each of the flower core parts 12 may be bent around a phantom line connecting a base end and a tip end of the petals 71 to form the curved petal body 12a. Owing to this, the central core body has a three-dimensional shape expanding in a direction crossing the extension direction, and the central part of the preserved flower arrangement 1 is made gorgeous. The resultant preserved flower arrangement 1 may have a shape that is not realized conventionally.

This will be described in more detail. The curved petal bodies 12a bent as described above may be located in the circumferential direction of the flower receptacle part 11. This allows the central core body 10 to expand in a direction crossing the extension direction. In addition to the three-dimensional expansion being realized by the bent curved petal bodies 12a, an outer profile of each of the bent curved petal bodies 12a represents a line directed toward the center of the flower receptacle part 11. The rose preserved flower arrangement 1 produced in this manner has lines extending toward the center of the central core body 10, in addition to a conventionally available shape in which the petals 71 and the like are stacked in the circumferential direction of the central core body 10. The rose preserved flower arrangement 1 produced in this manner may have the central core body 10 having a gorgeous structure and provide a novel representation that is not realized conventionally.

The petals may be bent around a phantom line connecting a tip end and another end of each flower core part 12. In this case, a central part of the bent petal including the phantom line connecting the tip end and the another end is represented by a curved line. The central core body 10 in which the curved petal bodies 12a having such curved lines are located on the circumference of the flower receptacle part 11 may provide a softer impression.

The curved petal bodies 12a may include the plurality of petals 71 layered on each other. In this case, the central core body 10 is thicker in a direction crossing the extension direction and has a gorgeous appearance because of the curved lines overlapping each other. The resultant rose preserved flower arrangement 1 may appear more beautiful.

The preserved flower arrangement according to the present invention corresponds to the rose preserved flower arrangement 1 in the above-described embodiment;

the flower core part corresponds to the flower core part 12 and the curved petal body 12a; and

the preserved flower 5 corresponds to the rose preserved flower 5.

The present invention is not limited to the above-described embodiment, and may be carried out in any of various embodiments.

For example, the preserved flower arrangement may be produced by use of a preserved flower of another flower than rose.

In the above embodiment, for example, the curved petal bodies 12a are each formed by bending the divided corolla 121 including the plurality of petals 71. Alternatively, for example, as shown in FIG. 12A to 12C, one petal 71 may be bent to form the curved petal body 12a. Still alternatively, the petals 71 separated from the corolla 70 one by one may be layered on each other and then are bent.

In this case, the central core body 10 may be made thicker by using a larger number of petals 71 to form the curved petal body 12a. By contrast, the central core body 10 may be made thinner by using a smaller number of petals 71 to form the curved petal body 12a. The rose preserved flower arrangement 1 produced in this manner may represent the personality of a creator thereof.

In the above embodiment, the petals 71 separated from the corolla 70 are used as the petals included in the flower core parts 12 or the outer petals 20. Alternatively, for example, petals separated from another rose preserved flower 5, a different type of preserved flower or the like may be used as the outer petals 20. Still alternatively, petals of a fresh flower, an artificial flower or the like may be used as the petals 71 included in the flower core parts 12 or as the outer petals 20.

In the above embodiment, for example, the central core body 10 having a novel shape is created by bonding the processed curved petal bodies 12a to the flower receptacle part 11 obtained as a result of the petals 71 being separated from the perianth. Alternatively, the central core body 10 may be a part left as a result the plurality of petals 71 being separated from the perianth. In this case, the central core body 10 has the flower receptacle part 11 and the corolla 70 integrated together in a natural state.

The rose preserved flower arrangement 1 produced in this manner is in a state close to the natural state.

### REFERENCE SIGNS LIST

1 . . . Rose preserved flower arrangement
10 . . . Central core body
11 . . . Flower receptacle part
12 . . . Flower core part
12a . . . Curved petal body
121 . . . Divided corolla
20 . . . Outer petal
21 . . . Protrusion
31 . . . Flower receptacle wire
32 . . . Flower core wire
33 . . . Tape
5 . . . Rose preserved flower
60 . . . Flower receptacle
61 . . . Reproductive organ
62 . . . Calyx
70 . . . Corolla
71 . . . Petal
S . . . Central space

1. A preserved flower arrangement, comprising:
a central core body obtained as a result of at least a plurality of petals being separated from a perianth of a preserved flower; and
a plurality of outer petals each having a surface caused to have a protrusion;
wherein the protrusions of the plurality of outer petals located on a circumference of the central core body, and the central core body, are bonded and secured to each other.

2. A preserved flower arrangement according to claim 1, wherein:
the central core body includes:
a flower receptacle part left as a result of a corolla being separated from the perianth; and
flower core parts located along an outer circumference of the flower receptacle part, the flower core parts each including a plurality of petals; and
the plurality of outer petals are bonded and secured to the flower core parts.

3. A preserved flower arrangement according to claim 2, further comprising:
a flower receptacle wire passing through the flower receptacle part in a direction crossing an extension direction in which the flower receptacle part extends, the flower receptacle wire being bent such that two ends thereof are directed downward in the extension direction, and being secured to the flower receptacle part; and
flower core wires passing through the flower core parts, the flower core wires being bent such that two ends of each thereof are directed in a predetermined direction, and being secured to the flower core parts;
wherein the flower receptacle wire and the flower core wires are secured to each other.

4. A preserved flower arrangement according to claim 2, wherein the flower core parts are each formed of a divided corolla obtained as a result of the corolla being divided along an extension direction in which the flower receptacle part extends.

5. A preserved flower arrangement according to claim 2, wherein the petals included in each of the flower core parts are bent around a phantom line connecting a base end and a tip end of the petals to form a curved petal body.

6. A preserved flower arrangement according to claim 5, wherein the curved petal body includes the plurality of petals layered on each other.

7. A method for producing a preserved flower arrangement, comprising:
a central core body formation step of separating a plurality of petals from a perianth of a preserved flower to form a central core body;
a protrusion formation step of causing each of outer petals to have a protrusion; and
a bonding step of bonding and securing the outer petals located on a circumference of the central core body, and the central core body, to each other.

8. A method for producing a preserved flower arrangement according to claim 7, wherein the central core body formation step includes:
a flower receptacle part formation step of separating a corolla from the perianth to form a flower receptacle part; and
a flower core part formation step of forming flower core parts located along an outer circumference of the flower receptacle part, the flower core parts each including a plurality of petals.

9. A method for producing a preserved flower arrangement according to claim 8, further comprising:
a flower receptacle wire bending step of causing a flower receptacle wire to pass through the flower receptacle part in a direction crossing an extension direction in which the flower receptacle part extends, and bending the flower receptacle wire such that two ends thereof are directed downward in the extension direction;
a flower core wire bending step of causing flower core wires to pass through the flower core parts, and bending the flower core wires such that two ends of each thereof are directed in a predetermined direction; and
a securing step of securing the flower receptacle wire and the flower core wires to each other.

10. A method for producing a preserved flower arrangement according to claim 8, wherein the flower core part formation step includes a division step of dividing the corolla along an extension direction in which the flower receptacle part extends.

11. A method for producing a preserved flower arrangement according to claim 8, wherein the flower core part formation step includes a bending step of bending the petals, included in each of the flower core parts, along a phantom line connecting a base end and a tip end of the petals.

12. A method for producing a preserved flower arrangement according to claim 11, wherein the bending step includes a layering step of layering the plurality of petals.
